(19) United States
(12) Patent Application Publication
(10) Pub. No.: US 2014/0054501 A1
(43) Pub. Date: Feb. 27, 2014

(54) GLOW IN THE DARK BUOYANT ARTICLES

(71) Applicant: Matthew Jess, Melbourne Victoria (AU)

(72) Inventors: Barry Rogers, Brooklyn (AU); Matthew Jess, Melbourne Victoria (AU)

(73) Assignee: Visual Signals Ltd., Brooklyn (AU)

(21) Appl. No.: 13/058,592

(22) PCT Filed: Aug. 7, 2009
(86) PCT No.: PCT/AU2009/001013

§ 371 Date: Apr. 12, 2013

(30) Foreign Application Priority Data
Aug. 12, 2008 (AU) 2008-904120
Jan. 19, 2009 (AU) 200900181

(51) Int. Cl. C09K 11/77; B63C 9/20

(52) U.S. Cl. CPC C09K 11/77; B63C 9/20
USPC 252/301.36; 441/89

(57) ABSTRACT

A buoyant article comprising a polymer containing particles of a photoluminescent material having a particle size of between 10 μm and 250 μm distributed throughout the polymer.

### BACKGROUND

There has long been a need to improve the visibility and ease of identification of buoyant articles on the water at night. Such articles include marine vessels floating in a waterway, whether inland, bay or at sea, and other buoyant articles such as marine lifesaving devices, lifebuoys, and other forms of buoys. It has been shown many times through accidents at sea that many vessels are simply very hard to see when floating or adrift at night. In the case of lifebuoys it has also been the experience that persons who have found themselves in the sea at night, even kept afloat through a lifebuoy, cannot be easily seen.

It is an object of the present invention to enable buoyant articles, including marine vessels such as small boats dingies, kayaks and runabouts, and other buoyant devices such as lifebuoys, to be seen easily at night by emergency search and rescue vessels or aircraft.

### SUMMARY

According to the present invention there is provided a buoyant article comprising a polymer containing particles of a photoluminescent material having a particle size of between 10 μm and 250 μm distributed throughout the polymer.

According to the present invention there is also provided a method for the manufacture of a buoyant article, comprising combining a polymeric material or prepolymer with particles of a photoluminescent material having a particle size of between 10 μm and 250 μm, and producing a buoyant article from the combination.

As one example, the buoyant article may be moulded into the shape of the buoyant article from the combination of the polymeric material or prepolymer with particles of a photoluminescent material.

An important factor is that the articles contain photon producing crystals (the photoluminescent or “photoluminous” material particles) integrated into the polymer material, to form a composite, which is used to manufacture the article. These photoluminescent materials produce a long lasting light emission, as described in more detail below. It is important for achieving the desired long afterglow effect for the particles to be present at the claimed particle size. Outside this particle size range the manufacturing is compromised due to the poor incorporation of the particles of photoluminescent material, and the glow effect produced by the composite of the polymer with the particles is also adversely affected.

According to preferred embodiments, the glowing light emission comes from the main body of the product, or the entire product, such as the hull of the marine vessel or the main body of the buoyancy device. This enables the position of the article to be made visible to show its position clearly to search and rescue people at night. This will be the case regardless of the weather conditions, and the position or orientation of the vessel in the water. The glow will be recognisable from long distances over a long period (throughout the night) and is reactivated indefinitely from any daylight exposure.

### BRIEF DESCRIPTION OF THE DRAWINGS

The invention will be described in further detail below with reference to some embodiments of the invention, and the Figures. In the Figures:

FIG. 1 is a perspective view of a marine vessel in accordance with one embodiment of the invention.

FIG. 2 is a front view of a lifebuoy in accordance with a second embodiment of the invention, photographed in standard light conditions.

FIG. 3 is a front view of the lifebuoy of FIG. 2 above, photographed in dark conditions, to demonstrate the glow effect.

### DETAILED DESCRIPTION

The present invention relates to buoyant articles made from polymers containing particles of a photoluminous material.

Buoyant Articles

The term “buoyant article” refers to any article that has buoyant properties when positioned on water. Examples include marine vessels and buoyancy devices. The term “marine vessel” is used in the sense of watercraft, being craft, vessels or vehicles designed to float on the water. The watercraft may be designed to move across or through the water. Examples include boats, runabouts, dingys (also referred to as dinghies), kayaks, canoes, lifeboats, surf skis, waveskis, surfboards, paddleboards, and so forth. The term “buoyancy device” refers to any articles that are buoyant in the water, and are not typically designed to move through the water. Examples include lifebuoys and other forms of marine life saving devices, rigid personal flotation devices, buoyancy aids, marker buoys, navigational buoys and all other forms of buoys.

In the case of marine vessels/watercraft, the subclass of marine vessels particularly suited to the present invention are those vessels that are typically small in size and/or have a main body part that can be formed from a polymer material (such as in a single unit, or a single moulding). Suitable vessels within this class therefore include those of between 1 and 5 meters in length, such as between 2 and 5 meters in length. Whilst that is the case, the invention can be applied to marine vessels of dimensions outside this range.

In the case of buoyancy devices, and specifically in the case of lifebuoys, marine life saving devices, rigid personal flotation devices and buoyancy aids, these may be of any suitable shape or configuration. One suitable shape for a lifebuoy is ring-shaped, although other shapes such as horseshoe-shapes are known. The device may also have additional reflective sections applied to its surface, such as reflective bands. The device may be hollow, and may contain a buoyant filling material to aid is buoyancy of the device. Suitably buoyant fillings include polyurethane or polystyrene polymers or foams.

The article may be constituted partly, substantially, or wholly from glow-in-the dark material, an in particular the particle-containing polymer. According to some embodiments, the particle-containing polymer forms a significant portion of the visible surface of buoyant article, and preferably at least 50%, more preferably at least 60%, even more preferably at least 70% and most preferably at least 80% of the visible surface of the article. According to some embodiments, the particle-containing polymer is formed into the shape (the main shape, the basic shape or the predominant shape) of the buoyant article.

The present invention extends to glow-in-the-dark marine vessels in which a significant proportion of the entire surface of the marine vessel is formed of a glow-in-the-dark material, and to glow-in-the-dark lifebuoys in which a significant proportion of the entire surface of the lifebuoy is formed of a glow-in-the-dark material.

Polymer Material

The choice of materials from which the above buoyant articles, such as marine vessels and buoyant devices can be constructed include polyolefins (such as polyethylene and polypropylene), polyurethanes, polyesters, acrylic polymers and polycarbonates. The polymers may be in homopolymer or copolymer form, or may be in the form of polymeric mixtures. The polymers may be in the form of pre-polymers, which are then polymerised at a suitable stage of manufacture to produce the final polymeric article. The term pre-polymer encompasses monomer mixtures that form the polymer on polymerisation.

The polymer is formed into a composite containing the selected particles of photoluminous material, of the required particle size.

The polymer composites containing the photoluminescent materials are then formed into the desired buoyant articles through one of the techniques described below.

In addition to the photoluminescent material, the polymer may further contain any other components or additives that may be found in polymer material, such as, without limitation, anti-block agents, anti-oxidants, fillers, flame retardants, impact modifiers, lubricating agents, nucleating agents, pigments, plasticisers, release agents, slip agents and/or UV stabilisers. However, the amounts of these agents should not be so high as to obscure or block the photoluminescent or glow effect produced by the photoluminescent material in the polymer composition. According to some embodiments, therefore, pigments and fillers that increase the opacity of the polymer material are avoided (i.e. the polymer contains no pigments and/or opacifying fillers). In this context, it is noted that the term “pigments” refers to non-photoluminescent pigments.

Photoluminescent Material

A key component is the component known as a photoluminescent (or photoluminous) material, crystal or pigment. The terms “photoluminescent” and “photoluminous” are used interchangeably. Such materials are also known as long afterglow photoluminous materials, crystals or pigments, or long after-glow phosphorescence or photo luminescent pigments, or after-glow phosphors.

In general terms, photoluminescent materials encompass rare-earth doped alkali and/or alkaline earth metal aluminates, alumino-silicates, alumino-phosphates and alumino-phospho-silicates, with optional halogenation.

There are several types of photoluminescent materials available in the art. One particular class of photoluminous materials that is well suited to the present invention are the halogenated alkali earth metal aluminates containing rare earth metal doping. Such photoluminescent materials include those with the formula:

aM.bAl.cX.0:fR

where M is an alkali earth metal selected from one or more of Sr, Ca, Mg and Ba;

X is halogen selected from F, Cl, Br and I;

R is one or more rare-earth element activator selected from the elements Ce, Pr, Nd, Pm, Sm, Eu, Gd, Tb, Dy, Ho, Er, Tm and Yb; and

a, b, c and f are variables having values in moles per 100 grams.

Suitable values for a, b, c and f are as follows:

0.0<a≦0.45 (such as 0.25≦a≦0.45)

0.0<b≦0.55 (such as 0.3≦b≦0.55)

0.0<c≦1 (such as 0.5≦c≦1)

0.0<f≦0.5 (such as 0.005≦f≦0.5)

Such long after-glow photoluminescent materials are available commercially from Visionglow of Australia (or its successors in title), and are as described in further detail in PCT/AU2006/001609 (WO2007/048201), the entirety of which is incorporated by reference.

Other suitable materials are alkali and/or alkaline earth metal alumino-phospho-silicates, with rare earth metal doping. Such materials are available commercially from Visionglow of Australia (or its successors in title) and are described in further detail in PCT/AU2006/001608 (WO2007/048200). These materials include:

aL.bM.cAL.dSi.pP.O:fR

wherein L is selected from Na and/or K;

M is a divalent metal selected from one or more of the group consisting of Sr, Ca, Mg and Ba;

Al, Si, P and O represent their respective elements;

R is selected from one or more rare earth element activators;

and wherein the variables a, b, c, d, p and f are:

0.0≦a≦0.1 (preferably 0.0<a≦0.1)

0.0≦b≦0.3 (preferably 0.0<b≦0.3)

0.0≦c≦0.4 (preferably 0.0<c≦0.4)

0.0≦d≦0.3 (preferably 0.05≦d≦0.3)

0.0≦p≦0.5 (preferably 0.1≦p≦0.5)

0.0<f≦0.25,

with the proviso that at least one of the variables d and p is >0, and at least one of the variables a and b is >0.

Rare earth element activators can be selected from one or more of Ce, Pr, Nd, Pm, Sm, Eu, Gd, Tb, Dy, Ho, Er, Tm and Yb and Lu, with a combination of Eu with a second rare earth activator being one notable example.

Other suppliers of photoluminescent materials (phosphorescent phosphors) to the industry include Nemoto, of Japan, and suitable materials are available from this company. Such materials include those described in their U.S. Pat. No. 5,686,022 and U.S. Pat. No. 5,424,006, the entirety of which are incorporated herein by reference. The materials of these two patents are rare-earth doped alkaline earth metal aluminates.

The materials of U.S. Pat. No. 5,686,022 include rare-earth doped M₁₋ₓAl₂O₄₋ₓ in which:

x is a positive or negative number except 0 (zero) (such as −0.33≦x≦0.60);

M is at least one metal element selected from a group consisting of calcium, strontium, and barium; and the dopant is a combination of europium and a second rare earth dopant (such as a rare earth selected from cerium, praseodymium, neodymium, samarium, terbium, dysprosium, holmium, erbium, thulium, ytterbium and lutetium).

The materials of U.S. Pat. No. 5,424,006 include rare-earth doped MAl₂O₄ in which:

M is at least one metal element selected from a group consisting of calcium, strontium and barium;

the material contains europium doping at a level of between 0.001% and 10%; and

the material contains doping by at least one further element selected from the group consisting of lanthanum, cerium, praseodymium, neodymium, samarium, gadolinium, dysprosium, holmium, erbium, thulium, ytterbium, lutetium, tin and bismuth, at a level of between 0.001% and 10%, in which the percentages are mol % relative to the metal element expressed by M.

In prior attempts to incorporate photoluminescent materials (in crystal form) into other materials (such as polymers) many challenges have been faced, which have appeared insurmountable to prior workers, as the crystals are abrasive and can damage machinery. These crystals have spinel forms and therefore are harder than most materials.

For this invention the photoluminescent material is required to be in the form of particles of a size that is not greater than 250 μm. This means that not more than 1%, preferably not more than 0.5% and preferably no particles at all are of a size above the 250 μm limit. The particle size is assessed by screening with a screen of the selected size.

Photoluminescent materials available in the art are supplied in the form of larger crystals, and therefore milling to this specific particle size is required. This size is very important so as to create the brightest possible glow when integrated into the selected polymer from which the buoyant article (such as boat or marine vessel) is moulded or constructed. The size is also important for effective distribution throughout the polymer matrix.

According to one embodiment, the particle size of the particles of photoluminescent material is between 10 μm and 250 μm. The references to a particle size of between 10 μm and 250 μm is to be read as requiring that all particles (at least 99% of the particles) are within this size range. Fines below 10 μm create processing problems for the polymeric material. Particles of a size above 250 μm are not distributed well enough in the polymer, and also the glow performance is reduced, so that the glow does not last for a sufficiently long period of time.

According to one embodiment, the particles of photoluminescent material preferably pass a screen size of between 200 and 250 μm. Specifically, the largest particles in the particle size range are preferably within this range, such that there are effectively no particles larger than 250 μm (as per the upper end of this limit, as determined by screening), and in a narrower embodiment, there are no particles above 200 μm (as per the lower end of this limit, as determined by screening). Thus according to one embodiment, the largest particles of photoluminescent material on the polymer material are not larger than 200 μm (as determined by screening). A margin of 1% is permitted in assessing compliance with this figure, however, preferably the margin is less than 0.5%, and most preferably there are absolutely no particles of photoluminescent material above 200 μm in the polymer material.

The particle size of the photoluminescent material is ideally selected to be appropriate for the size and shape of the desired end product. For larger products, such as products with a weight of around 50 to 1000 kg, for example 100 kg to 1000 kg, including marine vessels, the photoluminescent material particle size is suitably at least 70% within the range of 50-200 μm, preferably with at least 80% within this size range, and most preferably with at least 90% within this size range. The amount within this range can be even higher, such as 95% within the range, 98% within the range, and 99% within the range.

For smaller products, being products with a weight of under about 100 kg, such as under about 50 kg, including lifebuoys, marine life saving devices, rigid personal flotation devices and buoyancy aids, the particle size of the photoluminescent material is suitably smaller than the range described above for larger objects. According to one embodiment, the particle size of the photoluminescent material is at least 70% within the size range of 35-75 um, preferably with at least 80% within this size range, and most preferably at least 90% within this size range. The amount within this range can be even higher, such as 95% within the range, 98% within the range, and 99% within the range.

The amount of photoluminescent material incorporated into the polymer has been carefully determined through extensive test work. It has been found that the amount of photoluminescent material needs to be high enough to provide sufficient glow effect in the dark for a sufficiently long period of time (preferably at least 8 hours, and more preferably at least 10 hours, and ideally at least 12 hours). At the same time, if the amount added is too high, this can adversely impact on processing of the polymer, and can adversely affect the strength and robustness, such as the impact strength, and molecular memory (return to moulded shape after deformation) of the buoyant article.

In broad terms, allowing for the range of polymers permitted to be used in producing the buoyant article, the amount of photoluminescent material is suitably between 6 and 20% by weight of the polymer.

In the case of polyolefin materials, the amount is suitably between 9% and 12% by weight of the polymer material. Below this level the glow effect is not high enough. Above this level, the processing/product qualities are compromised to a prohibitive degree. These figures are suited to the construction of both larger articles (marine vessels such as boats) and smaller articles (such as lifebuoys and other buoyancy devices of a small size) from polyolefins, such as polyethylene and polypropylene. The particle size for each application is preferably as described above (70% within 50-200 μm for marine vessels, 70% within 35-75 μm for smaller buoyancy devices). Test work on levels of 15% revealed that such high levels of inclusion of the particulate photoluminescent material in these polymers does not produce an acceptable product.

In the case of polymers with higher clarity and/or more reflectivity, the amounts may fall within a wider range.

In the case of polyacrylics, the lower limit is 6%, and the upper limit is 12%. In the case of polycarbonates, the amounts may be higher—from 9% to 20%, preferably from 10% to 20%, but most suitably from 10% to 15%.

The preferred range across all polymer materials is 9% to 12%, preferably 10% to 12%, although as noted above, there are some exceptions where higher or lower amounts could be used.

Moulding and/or Construction Methods

The composite of the polymer and particles of photoluminescent material are used to construct or mould the desired form of buoyant article, such as a boat or other marine vessel, or the buoyancy device such as a lifebuoy.

Examples of construction techniques include the following:
1. The preferred method of construction is to mould the buoyant article such as boat, vessel or lifebuoy using rotational moulding machines. Thus, this method involves rotational moulding of a combination of a polymeric material or prepolymer with particles of a photoluminescent material having the desired particle size into the shape of a buoyant article (such as a boat, vessel or lifebuoy).
2. The second method is to apply the composition polymers to a mould in layers using a wet dry layup system, such as that used to create fibre glass objects. Thus, this method involves applying a combination of a polymeric material or prepolymer with particles of a photoluminescent material having the desired particle size into a mould of a shape that corresponds to the shape of the buoyant article (such as a boat, vessel or lifebuoy). The application may comprise applying layers of the polymer/particle combination to the mould.

### EXAMPLES

1. Marine Vessels

In the case of marine vessels, the designs of the boats or vessels may vary in shape and size according to the constructors desired outcome.

Various moulds to accomplish the finished product will be embraced by the constructor.

The afterglow exhibited from boats or marine vessel is novel and extraordinary and represents the difference from other similar constructed boats and vessels which do not contain the photoluminous crystal particles of the size range described above.

Notwithstanding, the present invention extends to glow in the dark boats or marine vessels (and indeed to all buoyant articles) produced from all forms of photoluminous compositions.

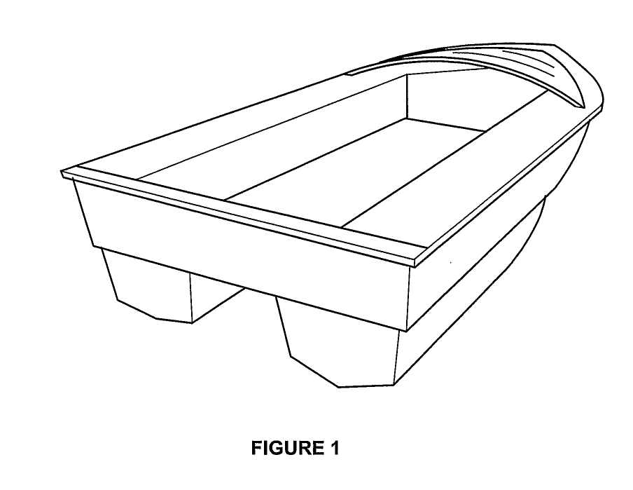

An example of a glow in the dark boat or marine vessel of one form or embodiment of the invention is illustrated in FIG. 1. The boat of this example is in the form of a small boat, but it will be understood that the invention is not limited to this form of vessel, or to this design.

The boat of FIG. 1 comprises a hull which has been moulded through rotational moulding (although other techniques including those described above could have been used). The boat hull was moulded from medium density polyethylene containing particles of halogenated alkali earth metal aluminate with rare earth metal doping, with more than 996 of the particles being of a size within the range of 10-250 μm. The particle size range included greater than 70% of the particles within the range of 50-200 μm. This photoluminescent material was obtained in larger crystal form from Visionglow, of Australia, and was ground to the target particle size. This material was 0.04SrO. 0.96SrF₂. Al₂O₃: 0.002Eu, 0.008Dy, the product from example 1 of WO2007/048201. The amount of photoluminescent particles in the polymer matrix was 10% by weight of the polyethylene. The final product obtained was a strong high performance boat, weighing about 550 kg after moulding but before trimming of excess polymer, and about 500 kg following trimming.

The polymers containing the photoluminous material particles in the identified particle size ranges have the desired properties required for the photoluminous crystal particles to integrate in a uniform way within the moulded product after curing.

Tests conducted prove that the boat or vessel moulded pursuant to this invention reveal a strong high performance profile glowing in the dark at night, in either green gold or blue. A blue glow is produced by using a phosphorescent material that produces this coloured glow, such as is available from Visionglow of Australia.

The preferred moulding method is rotational moulding which utilises a special designed machine controlling the reaction of the constituents used in the manufacturing process. A rotomoulding machine will in most cases produce 1 boat hull per hour. There is however a certain skill in operating this machine in order to produce the best quality product. The finished boat is normally removed from the mould after cooling has set the form hard.

FIG. 1 shows a typical profile of a boat rotationally moulded from the materials described herein.

2. Buoyancy Devices

In the case of buoyancy devices such as lifebuoys, marine life saving devices, rigid personal flotation devices and buoyancy aids, these may be of any suitable size, shape or configuration suited to the intended purpose. Thus, various mould shapes/sizes to accomplish the desired finished product are envisaged. One suitable shape for a lifebuoy is ring-shaped, although other shapes such as horseshoe-shapes are known.

Generally, the outer surface portion of the buoyancy device such as lifebuoy is moulded with a hollow inner cavity. This cavity may then be filled with a buoyant filling material to aid buoyancy of the device. Suitably buoyant fillings include polyurethane or polystyrene polymers or foams.

The device may also have additional reflective sections applied to its surface, such as reflective bands.

The buoyancy device such as a lifebuoy constructed from the described materials gives off a highly visible light glowing in the dark all night long after having exposure of just a few minutes of sunlight or 10 minutes of artificial light prior to exposure in darkness. The glow can be recognised from at least 100 meters away and will last up to 12 hours in darkness.

Existing lifebuoys are generally made from polyethylene or similar material which may be coloured orange, but no existing lifebuoys have a body that glows in the dark.

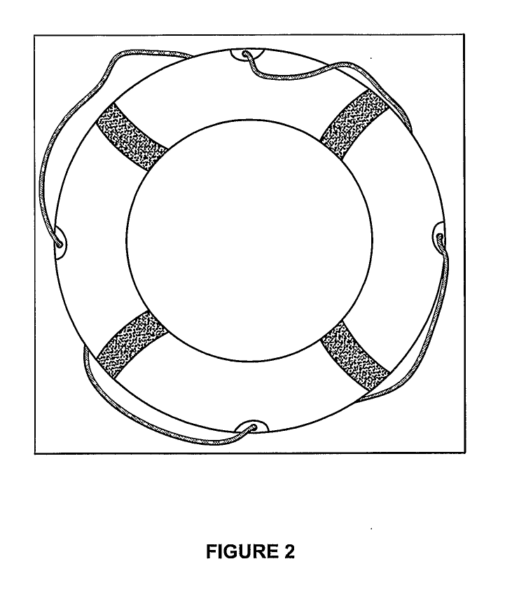

An example of a glow in the dark lifebuoy of one form or embodiment of the invention is illustrated in FIG. 2. The lifebuoy of this example is ring-shaped, but it will be understood that the invention is not limited to this form of buoyancy device, or to this design.

The lifebuoy of FIG. 2 comprises a main body surface which has been moulded through rotational moulding (although other techniques including those described above could have been used). The body of the lifebuoy was moulded from medium density polyethylene containing particles of halogenated alkali earth metal aluminate with rare earth metal doping, with more than 99% of the particles being of a size within the range of 10-250 μm. The particle size range included greater than 70% of the particles within the range of 35-75 μm. There were not more than 1% of particles above 75 μm, and at least 70% of the particles were above 35 μm. This photoluminescent material was obtained in larger crystal form from Visionglow, of Australia, and was ground to the target particle size. This material was 0.04SrO. 0.96SrF₂. Al₂O₃: 0.002Eu, 0.008Dy, the product from example 1 of WO2007/048201. The amount of photoluminescent particles in the polymer matrix was 10% by weight of the polyethylene.

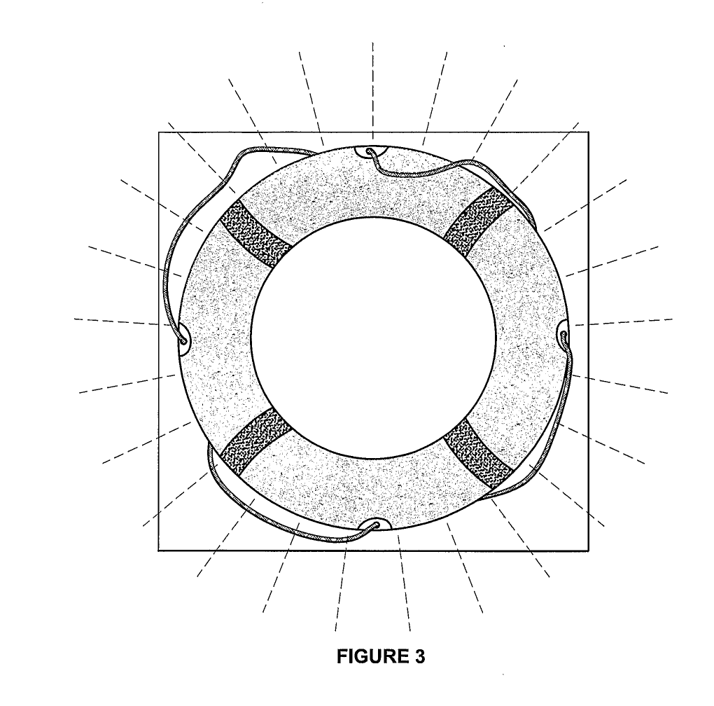

The finished lifebuoy body was removed from the mould after cooling had set the form hard. After rotational moulding of the body of the lifebuoy, the lifebuoy was filled with a buoyant material, and the surface of the glow in the dark lifebuoy had retro-reflective bands applied, as illustrated in FIG. 2. When placed in the dark, the lifebuoy glows, as shown in FIG. 3.

Tests conducted prove that the lifebuoy produced pursuant to this invention reveals a strong high performance profile glowing in the dark at night, in either green gold (as in the example described above) or blue. A blue glow is produced by using a phosphorescent material that produces this coloured glow, such as is available from Visionglow of Australia.

1. A buoyant article comprising a polymer containing particles of a photoluminescent material having a particle size of between 10 μm and 250 μm distributed throughout the polymer.

2. The buoyant article of claim 1, wherein the particle-containing polymer forms at least 50% of the visible surface of the article.

3. The buoyant article of claim 1, wherein the particle-containing polymer is formed into the shape of the buoyant article.

4. The buoyant article of claim 1, wherein the polymer is selected from the group consisting of polyolefins, polyurethanes, polyesters, acrylic polymers, polycarbonates and combination or copolymers thereof.

5. The buoyant article of claim 1, wherein the photoluminescent material is a rare-earth doped alkali and/or alkaline earth metal aluminate, alumino-silicate, alumino-phosphate or alumino-phospho-silicate, with optional halogenation.

6. The buoyant article of claim 1, wherein the photoluninescent material is a halogenated alkali earth metal aluminates containing rare earth metal doping.

7. The buoyant article of claim 6, wherein the photoluminescent material has the formula:
aM.bAl.cX.0:fR
where M is an alkali earth metal selected from one or more of Sr, Ca, Mg and Ba;
X is halogen selected from F, Cl, Br and I;
R is one or more rare-earth element activator selected from the elements Ce, Pr, Nd, Pm, Sm, Eu, Gd, Tb, Dy, Ho, Er, Tm and Yb; and
a, b, c and f are variables having values in moles per 100 grams.

7. (canceled)

8. The buoyant article of claim 7, wherein the values for a, b, c and f are:
0.25≦a≦0.45
0.3≦b≦0.55
0.5≦c≦1
0.005≦f≦0.5.

9. The buoyant article of claim 1, wherein the amount of photoluminescent material incorporated into the polymer is between 6 and 20% by weight of polymer.

10. The buoyant article of claim 1, wherein the buoyant article is in the form of a marine vessel.

11. The buoyant article of claim 10, wherein the buoyant article is in the form of a boat, runabout, dingy, kayak, canoe, lifeboat, surfski, waveski, surfboard or paddleboards.

12. The buoyant article of claim 1, wherein the particle size of the photoluminescent material is at least 70% between 50 and 200 μm.

13. The buoyant article of claim 1, wherein the buoyant article is in the form of a buoyancy device.

14. The buoyant article of claim 12, wherein the buoyancy device is in the form of a lifebuoys, a marine life saving device, a rigid personal flotation device or a buoyancy aid.

15. The buoyant article of claim 1, wherein the particle size of the photoluminescent material is at least 70% between 35 and 75 μm.

16. The buoyant article of claim 1, wherein the polymer is a polyolefin, and the amount of photoluminescent material is between 9 and 12% by weight of the polymer.

17. A glow-in-the-dark marine vessel in which a significant proportion of the entire surface of the marine vessel is formed of a glow-in-the-dark material.

18. (canceled)

19. A method for the manufacture of a buoyant article, comprising combining a polymeric material or prepolymer with particles of a photoluminescent material having a particle size of between 10 μm and 250 μm, and producing a buoyant article from the combination.

20-28. (canceled)

29. The method of claim 19, wherein the particle size of the photoluminescent material combined with the polymer is at least 70% between 50 and 200 μm.

30. (canceled)

31. The method of claim 19, wherein the particle size of the photoluminescent material combined with the polymer is at least 70% between 35 and 75 μm.

32. (canceled)

33. The buoyant article of claim 7, wherein the values for a, b, c and f are:
0.0<a≦0.45
0.0<b≦0.55
0.0<c≦1
0.0<f≦0.5.
